(19) United States
(12) Patent Application Publication
(10) Pub. No.: US 2008/0184476 A1
(43) Pub. Date: Aug. 7, 2008

(54) Tub Cover Lifting and Stowing Device

(76) Inventors: Eric Albert, Williamsport, PA (US); Lynda Livingston, Williamsport, PA (US)

Correspondence Address: ZALE Patent Law, 434 Lackawanna Ave., Suite 200, Scranton, PA, 18503-2053, US

(21) Appl. No.: 12/027,395

(22) Filed: Feb. 7, 2008

Related U.S. Application Data
(60) Provisional application No. 60/899,993, filed on Feb. 7, 2007.

(51) Int. Cl. A47K 3/02; B23P 11/00

(52) U.S. Cl. 4/580; 29/428

(57) ABSTRACT

The present invention relates to a novel lifting and stowing device for a cover [1100] for a spa or tub [20]. Cover [1100] has a near piece [1110] a central piece [1130] and a far piece [1150] which fold and are stored in a compact position out of the way against the side of tub [20]. The invention [1000] employs a multi-link frame [1300] supporting the cover [1100] designed to lift and fold the cover pieces out of the way. Multi-link frame [1300] employs a main lift [1330] and a secondary lift [1350] of either side of a top edge [23] of tub [20]. Lifts [1330, 1350] retract in a scissor-like fashion to fold cover near piece [1110], central piece [1130] and far piece [1150] against each other. The cover lifting and stowing device [1000] lifts and folds cover [1100] inward toward the pivot point to move the cover weight closer to the pivot point reducing the required lifting torque.

### CROSS REFERENCE TO RELATED APPLICATIONS

This patent application is related to, and claims priority from U.S. Provisional Patent Application Ser. No. 60/899,993 filed Feb. 7, 2007 “Tub Cover Lifting and Stowing Device” by E. Albert and L. Livingston. All content of this parent application is incorporated by reference as if set forth in its entirety herein.

### BACKGROUND OF THE INVENTION

1. Field of the Invention

The present invention relates to a device for automatically covering a tub or tank and more specifically to a multi-articulated frame for automatically covering a tub or tank.

2. Discussion of Related Art

Spas and hot tubs are typically left filled with water after use. They are potentially dangerous if small children fall into them. Therefore, covers are used on the tubs when not in use to protect little ones. Since children may walk on the covers, they must be able to withstand a certain amount of weight before collapsing. There are standards which determine the amount of weight which each cover must withstand.

Since hot tubs are typically heated to approximately 100 Deg. F., they tend to lose heat to the atmosphere. This is especially true of tubs used in the winter months, outside.

If one were to leave the tub at the ambient temperature, it would take quite a long time to heat it to the proper temperature before use. Waiting an extended period of time tends to be a waste of time and takes away the enjoyment of using the tub.

If one were to keep the tub constantly heated, it becomes very costly.

One way to keep the tub near operating temperature and prevent the loss of heat is to use a thermal cover. Using a large amount of insulation provides less heat loss. This, coupled with the need for a cover having or exceeding the strength requirements discussed above, results in a heavy, bulky cover. The larger the tub, the heavier and more bulky this cover becomes.

It would not be such a large problem if it were only removed and replaced occasionally, however, these hot tubs may be used daily. The more frequently these are used, the greater the problem.

Also, since the covers are quite large, there is the problem of stowing them when the tub is in use.

Currently there is a need for a device for opening, closing and stowing covers on tubs which is easy to operate.

### SUMMARY OF THE INVENTION

One embodiment of the present invention is a cover lifting device for removing a cover from a tub, comprising:
a frame attached to said tub, the frame comprising:
   i. a near section pivotally attached to said tub, the near section also having a second pivot attachment point; and
   ii. a central section for supporting the cover, having a third pivot attachment for pivotally connecting to the second pivot attachment point of the near section, allowing the cover and frame to pivot off of the tub and to be stored out of the way.

The present invention may also be embodied as a cover lifting device for removing a cover from a tub comprising:
a frame attached to said tub, the frame comprising:
   i. a near section pivotally attached to said tub at a pivot point; and
   ii. a central section for supporting the cover retractably connected to the near section, such that the central portion may retract moving its weight closer to the pivot point reducing torque required to rotate the frame and cover off of the tub.

The present invention may also be embodied as a method of creating a device for lifting off and stowing a cover of a tub, comprising the steps of:
a) pivotally attaching a near section having a cover portion to said tub;
b) connecting a central section having a cover to the near section;
c) connecting an end section having a cover to the central section;
d) providing a device which sequentially folds the far section onto the central section, then both of these sections onto the base section; and
e) providing a device which pivots the folded sections off of the tub.

The present invention may also be embodied as a 14. A cover lifting device for removing a cover from a tub having a frame comprising:
a) a main actuator being an elongated member having a first end and a second end, the first end rotatably connected to a fixed base;
b) a main support being an elongated member having a first end and a second end, the first end connected to the second end of the main actuator;
c) a secondary actuator being an elongated member being shorter than the main actuator, having a first end and a second end, the first end rotatably coupled to the fixed base;
d) a secondary support being an elongated member having a first end and a second end, the first end connected to the second end of the secondary actuator;
e) an end support rotatably connected to the second end of the main support and the second end of the secondary support; and
f) main-secondary pivot rotatably connecting the main actuator to the main support such that rotating the main actuator away from the base causes the first support to move toward its first end to a greater extent than the main support, thereby causing lifting and folding of the attached end support and said cover.

### OBJECTS OF THE INVENTION

It is an object of the present invention to provide a device which automatically places a cover over a tub which is strong enough to meet safety standards.

It is another object of the present invention to provide a device which automatically places a cover over a tub which effectively minimizes heat loss.

It is another object of the present invention to provide a device which automatically places a cover over a tub which is easy to operate.

It is another object of the present invention to provide a device which automatically retracts a cover from a tub which compactly stows the cover.

### BRIEF DESCRIPTION OF THE DRAWINGS

The invention itself, both the organization and method of operation, together with the described objects and advantages, may best be understood by reference to the following description taken in conjunction with the accompanying drawings in which:

FIG. 1 is a perspective view of a hot tub with a cover shown in phantom and the cover lifting and stowing device in its fully covered position according to the present invention.

FIG. 2 is a side elevational view of the embodiment of the cover lifting and stowing device shown in FIG. 1, as the cover begins to be lifted from the tub.

FIG. 3 is a side elevational view of the embodiment of the cover lifting and stowing device shown in FIGS. 1 and 2, as the cover is lifted further from the tub.

FIG. 4 is a side elevational view of the embodiment of the cover lifting and stowing device shown in FIGS. 1, 2 and 3, in a position close to its fully retracted position.

### DETAILED DESCRIPTION OF THE INVENTION

As stated in the ‘Background of the Invention’ above, it is important that a strong cover be placed over open tubs, such as hot tubs and spas, to prevent small children and animals from falling through the cover into the tub and drowning. These must be sturdy enough to meet or exceed safety standards set forth for these types of covers.

The covers must also contain the heat to allow the hot tubs to be economical, and minimize the waste of heat and energy.

Since the covers are over the tub for a long period of time, they absorb a good amount of evaporating water vapor and become much heavier.

All of these factors result in a large and heavy cover. These covers must be repeatedly removed and stowed during use of the tub and replaced after use. This takes a great deal of effort.

The present invention meets all of the above specified requirements. It allows for a sturdy cover. It also allows for a thick, sturdy thermal cover which meets safety standards protecting children and pets. It is designed to automatically retract the cover and fold it into a compact storage position against the side of the tub.

Since the cover is typically large and bulky, the cover has to be split into pieces, each carried by a frame.

The present invention is specially designed to lift heavy and bulky covers.

If one were to pivot a cover at a fulcrum point, being one edge of the tub, it would require considerable strength. This is because the torque required is a function of the weight being pivoted, and the distance of the weight from the fulcrum point.

The weight near the pivot point does not add as much to the total torque required to lift the cover as much as the same amount of weight does at the far side (away from the pivot point).

Therefore, the torque required to pivot the cover will be greatly reduced by moving the weight at the far end to a location closer to the pivot point.

The present invention has a mechanism which does exactly that. It folds the far end of the cover toward the pivot point. This is done by the embodiment described below in a gradual sense as the cover is being pivoted. The mechanism is designed specifically for this purpose.

An illustration of one embodiment is shown in the following figures. All parts having the same number in the figures represents the same part.

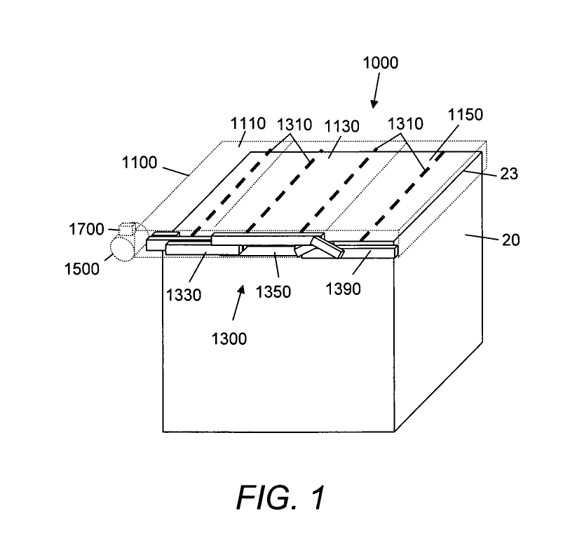

FIG. 1 is a perspective view of a hot tub with a cover 1100 shown in phantom and the cover lifting and stowing device 1000 in its fully covered position according to the present invention. (There is also a mechanism on the other side which is not shown here for clarity.) Here it can be seen that it is designed to reduce heat loss and totally cover the tub, reducing the chance that a child may fall into the tub. Also, it includes cross braces 1310 which make it sturdy enough to allow children to walk over it without it collapsing.

Cover 1100 is made of a near piece 1110, a central piece 1130 and a far piece 1150. The near piece 1110 is attached to a main lift 1330. The far piece 1150 is attached to a secondary lift 1350.

A motor 1500, controlled by a control device 1700 in this embodiment, activates a multi-link frame 1300 supporting the cover 1100 to lift, rotate and fold cover 1100 into a compact stored position. Multi-link frame 1300 includes a near section 1330, a central section 1350 and a far section 1390. The frame 1300 rests on either side of an upper edge 23 of a tub 20. It also includes cross braces 1310 spanning between sides of main lift 1330 and the secondary lift 1350 to act as supports for cover 1100.

Multi-link frame 1300 may also be actuated by manual mechanical means, such as cranks and gears, in an alternative embodiment.

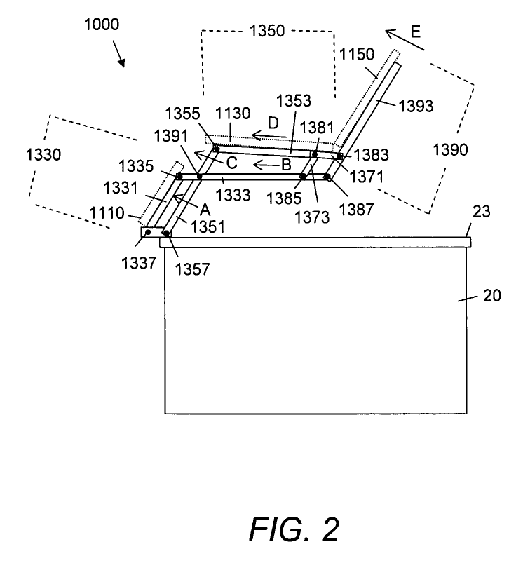

FIG. 2 is a side elevational view of the embodiment of the cover lifting and stowing device 1000 shown in FIG. 1, as the near piece 1110, central piece 1130 and far piece 1150 of the cover begin to be lifted from the tub 20.

The frame near section 1330 includes a main actuator 1331, a secondary actuator 1351 and their associated pivot and attachment points for carrying cover near piece 1110.

The frame central section 1350 includes a main support 1333, a secondary support 1353 and their associated pivot and attachment points for carrying the cover central piece 1130.

The frame end section 1390 includes end support 1393. It also includes upper link 1371 and near link 1373, and their associated pivot and attachment points for carrying cover 1150.

As the motor (1500 of FIG. 1), not shown in FIG. 2, causes then main actuator 1331 to rotate according to arrow “A” about main base pivot 1337, main actuator 1331 pulls main support 1333 at main actuator-support pivot 1335 in the direction marked “B”.

Main support 1333 is attached to secondary actuator 1351 at secondary actuator-support pivot 1391, causing secondary actuator 1351 to rotate according to arrow “C”.

Secondary actuator 1351 is attached to secondary support 1353 and pulls it in the direction marked by arrow “D”. Due to the geometry, secondary support 1353 moves further in the direction marked by arrow “D” than main support 1333 moves in the direction marked by the arrow “B”.

The main support 1333 is rotatably connected to end support 1393 at a far lower pivot 1387.

Secondary support 1353 is rotatably attached to an upper link 1371 at the near upper pivot 1381. Upper link 1371 connects to end support 1393 at far upper pivot 1383.

Near link 1373 acts as a stabilizer connecting between secondary support 1353 and main support 1333. Near link 1373 is rotatably connected to secondary support 1353 at a near upper pivot 1381. Near link 1373 is rotatably connected to main support 1333 at near lower pivot 1385.

Since main support 1333 is moving in the direction marked by arrow “B” slower and a shorter distance than secondary support 1353 and upper link 1371 are moving in the direction marked by arrow “D”, the difference causes end support 1393 to rotate in the direction marked by arrow “E”.

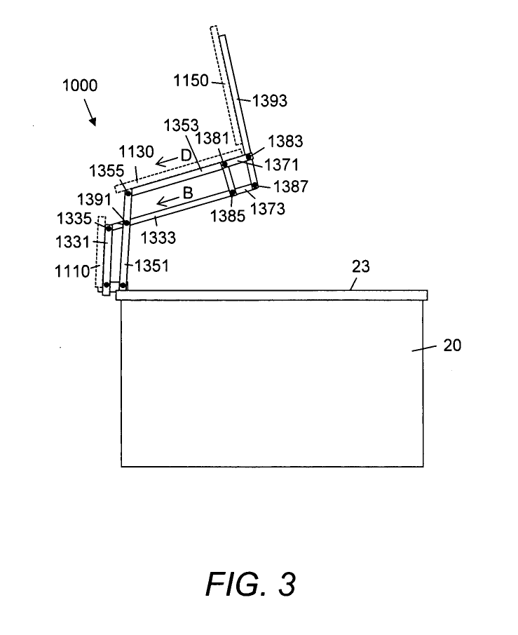

FIG. 3 is a side elevational view of the embodiment of the cover lifting and stowing device shown in FIGS. 1 and 2, as the cover is lifted further from the tub.

In this figure it can be seen that secondary support 1353 and upper link 1371 have moved further in the direction marked by arrow “D” than main support 1333 has moved in the direction marked by arrow “B”. This results in the entire apparatus lifting and moving away from the tub 20 toward a stowed position.

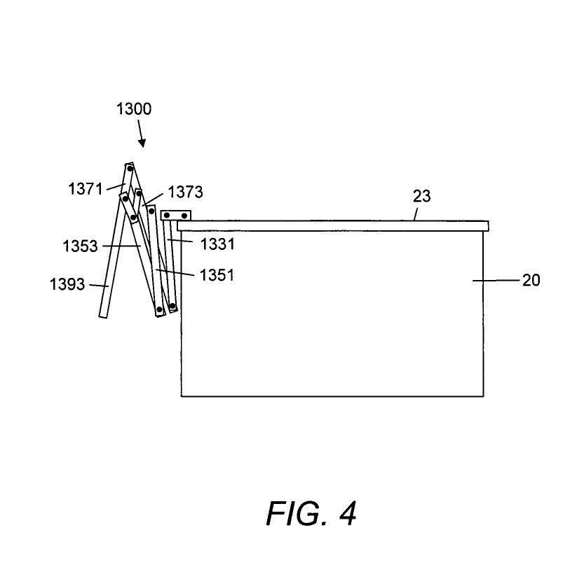

FIG. 4 is a side elevational view of the embodiment of the cover lifting and stowing device 1000 shown in FIGS. 1, 2 and 3, in an almost fully retracted position. The cover 1100 is not shown for clarity. Here it can be seen that the end support 1393 is fully folded downward in a compact resting position. Secondary actuator 1351 has been unfastened to allow the multi-link frame 1300 to fold downward against the side of tub 20. This folds the frame and cover 1100 in a compact fashion out of the way until needed.

Motor 1500 and controller device 1700 of FIG. 1 may be an electric motor and motor controller, respectively. In an alternative embodiment, a manual crank system is used in place of motor 1500 and controller device 1700.

In another embodiment, there may be one or more additional sections attached to the far section. These are attached serially and extend in a distal direction. Each of these is designed to fold onto the next nearer section, thereby folding up toward the pivot point. Once folded, then sections are pivoted off of the tub.

In an alternative embodiment, far section can slide relative to the central section toward the pivot. This effectively moves the weight and center of gravity closer to the pivot point. This minimizes the amount of torque required to pivot the cover off of the tub.

The above embodiments were provided for exemplary purposes. The cover may be split into a different number of parts. Also, there may be more or fewer linkages of the frame to perform the same function. Other known means may also be used to actuate the frame.

Although preferred embodiments have been described, other embodiments and modifications of the invention may become apparent to the reader. Such embodiments and modifications of the preferred and exemplary embodiments are intended to be within the scope of the present application.

What is claimed is:

1. A cover lifting device for removing a cover from a tub, comprising:
a frame attached to said tub, the frame comprising:
i. a near section pivotally attached to said tub, the near section also having a second pivot attachment point;
ii. a central section for supporting the cover, having a third pivot attachment for pivotally connecting to the second pivot attachment point of the near section, allowing the cover and frame to pivot off of the tub and to be stored out of the way.

2. The cover lifting device of claim 1 wherein:
a) the central section further comprises a third pivot attachment point, and
b) further comprises a far section for supporting said cover having a fourth pivot attachment for pivotally connecting to the third pivot attachment point of the central section.

3. The cover lifting device of claim 2 wherein:
the far section is adapted to automatically fold toward the near section to move its weight closer to the pivot point and minimize torque required to lift said cover.

4. A cover lifting device for removing a cover from a tub comprising:
a frame attached to said tub, the frame comprising:
i. a near section pivotally attached to said tub at a pivot point;
ii. a central section for supporting the cover retractably connected to the near section, such that the central portion may retract moving its weight closer to the pivot point reducing torque required to rotate the frame and cover off of the tub.

5. The cover lifting and stowing device of claim 4 wherein the central section is slidingly connected to the near section such that it may slide relative to the near section so as to move its weight closer to the pivot point.

6. The cover lifting and stowing device of claim 5 further comprising:
a far section for carrying said cover retractably attached to the central portion, such that it may slide relative to the central section so as to move its weight closer to the pivot point, thereby reducing torque required to pivot the cover and frame off of the tub.

7. The cover lifting and stowing device of claim 6 wherein the tub cover is a single piece.

8. The cover lifting and stowing device of claim 6 wherein the cover is made of several pieces.

9. A method of creating a device for lifting off and stowing a cover of a tub, comprising the steps of:
a) pivotally attaching a near section having a cover portion to said tub;
b) connecting a central section having a cover to the near section;
c) connecting an end section having a cover to the central section;
d) providing a device which sequentially folds the far section onto the central section, then both of these sections onto the base section; and
e) providing a device which pivots the folded sections off of the tub.

10. The method of claim 9 wherein the step of providing a device comprises the steps of:
providing a frame having multiple sections extending distally from the attachment point to its furthest section, which is designed to fold sections onto each other starting with the section furthest from the attachment point and moving toward the attachment point.

11. The method of claim 10 further comprising the step of:
pivoting the folded sections off of the tub and storing them alongside of the tub.

12. The method of claim 10 wherein the step of connecting a central section having a cover to the near section comprises:
connecting a central section having a cover to the near section and employing a single piece cover.

13. The method of claim 10 wherein the step of connecting an end section having a cover to the central section comprises:
connecting a central section having a cover to the near section such that a multiple piece cover is employed and thermal insulation is employed between the pieces.

14. A cover lifting device for removing a cover from a tub having a frame comprising:
a) a main actuator being an elongated member having a first end and a second end, the first end rotatably connected to a fixed base;
b) a main support being an elongated member having a first end and a second end, the first end connected to the second end of the main actuator;
c) a secondary actuator being an elongated member being shorter than the main actuator, having a first end and a second end, the first end rotatably coupled to the fixed base;
d) a secondary support being an elongated member having a first end and a second end, the first end connected to the second end of the secondary actuator;
e) an end support rotatably connected to the second end of the main support and the second end of the secondary support; and
f) main-secondary pivot rotatably connecting the main actuator to the main support such that rotating the main actuator away from the base causes the first support to move toward its first end to a greater extent than the main support, thereby causing lifting and folding of the attached end support and said cover.
